(19) United States
(12) Patent Application Publication
(10) Pub. No.: US 2026/0219630 A1
(43) Pub. Date: Jul. 30, 2026

(54) MEMBER ATTACHMENT STRUCTURE

(71) Applicant: FUJIFILM Business Innovation Corp., Tokyo (JP)

(72) Inventors: Yoichi TAKEUCHI, Kanagawa (JP); Toshihiro GODA, Kanagawa (JP); Yuya SHIOKAWA, Kanagawa (JP)

(73) Assignee: FUJIFILM Business Innovation Corp., Tokyo (JP)

(21) Appl. No.: 19/299,482

(22) Filed: Aug. 14, 2025

(30) Foreign Application Priority Data
Jan. 27, 2025 (JP) 2025-011728

(51) Int. Cl. G03G 21/16

(52) U.S. Cl. CPC G03G 21/1647; G03G 2221/1696

(57) ABSTRACT

A member attachment structure includes: a main body; an attachment member to be attached to an attachment surface formed in the main body and inclined with respect to a horizontal plane; a temporary holding part that is provided on the main body and the attachment member and via which the attachment member is temporarily held on the main body; a positioning part that is provided on the main body and the attachment member and that positions a part of the attachment member with respect to the main body in a horizontal direction along the attachment surface and in an inclined direction along the attachment surface in a state in which the attachment member is temporarily held on the main body via the temporary holding part; another positioning part that is provided on the main body and the attachment member and that positions another part of the attachment member, away from the part in the horizontal direction, with respect to the main body in the inclination direction in a state in which the attachment member is temporarily held on the main body via the temporary holding part; and a fastener with which the attachment member positioned by the positioning part and the other positioning part is attached to the main body.

### CROSS-REFERENCE TO RELATED APPLICATIONS

This application is based on and claims priority under 35 USC 119 from Japanese Patent Application No. 2025-011728 filed Jan. 27, 2025.

### BACKGROUND

### (i) Technical Field

The present disclosure relates to a member attachment structure.

### (ii) Related Art

Japanese Unexamined Patent Application Publication No. 2010-188804 discloses a structure for temporarily fixing an electronic device. The structure includes: a bracket fixed to one surface of a room; a device body to be attached to the bracket; a guide hole provided in one of the device body and the bracket; a temporary holding hook provided on the other at a position shifted from the center of gravity and capable of being fitted into the guide hole; and a positioning hole provided in one of the device body and the bracket, and a positioning rib provided on the other and fitted into the positioning hole so that the positions of screw holes are aligned, the positioning hole and the positioning rib being provided on the side on which the device body, which is temporarily held by the temporary holding hook passed through the guide hole and is inclined due to the shift of the center of gravity, is closer to the bracket.

### SUMMARY

In the related art, when a member to be attached (attachment member) is attached to a main body, the attachment member is first temporarily held on the main body. Then, the attachment member in a temporarily held state is moved and positioned with respect to the main body, and the attachment member in a positioned state is attached to the main body with fasteners.

Aspects of non-limiting embodiments of the present disclosure relate to positioning an attachment member with respect to a main body by causing the attachment member to be temporarily held on the main body, and attaching the attachment member in a positioned state to the main body with fasteners.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a member attachment structure including: a main body; an attachment member to be attached to an attachment surface formed in the main body and inclined with respect to a horizontal plane; a temporary holding part that is provided on the main body and the attachment member and via which the attachment member is temporarily held on the main body; a positioning part that is provided on the main body and the attachment member and that positions a part of the attachment member with respect to the main body in a horizontal direction along the attachment surface and in an inclined direction along the attachment surface in a state in which the attachment member is temporarily held on the main body via the temporary holding part; another positioning part that is provided on the main body and the attachment member and that positions another part of the attachment member, away from the part in the horizontal direction, with respect to the main body in the inclination direction in a state in which the attachment member is temporarily held on the main body via the temporary holding part; and a fastener with which the attachment member positioned by the positioning part and the other positioning part is attached to the main body.

### BRIEF DESCRIPTION OF THE DRAWINGS

Exemplary embodiment of the present disclosure will be described in detail based on the following figures, wherein:

FIG. 1 schematically illustrates a configuration of an image forming apparatus in which a member attachment structure according to an exemplary embodiment of the present disclosure is used;

FIG. 2 illustrates a configuration of a toner image forming unit of the image forming apparatus in which the member attachment structure according to the exemplary embodiment of the present disclosure is used;

FIG. 3 is a perspective view illustrating a state in which a board box is attached to the image forming apparatus by using the member attachment structure according to the exemplary embodiment of the present disclosure;

FIG. 4 is an exploded perspective view illustrating the board box to be attached to the image forming apparatus by using the member attachment structure according to the exemplary embodiment of the present disclosure, and a back plate;

FIG. 5 is an exploded perspective view illustrating the board box to be attached to the image forming apparatus by using the member attachment structure according to the exemplary embodiment of the present disclosure, and the back plate;

FIGS. 6A and 6B are sectional views illustrating the member attachment structure according to the exemplary embodiment of the present disclosure, the member attachment structure being provided on one side of the board box in the width direction;

FIGS. 7A and 7B are sectional views illustrating the member attachment structure according to the exemplary embodiment of the present disclosure, the member attachment structure being provided on the other side in the width direction of the board box; and

FIGS. 8A and 8B are rear views illustrating the member attachment structure according to the exemplary embodiment of the present disclosure, the member attachment structure being provided on the other side in the width direction of the board box.

### DETAILED DESCRIPTION

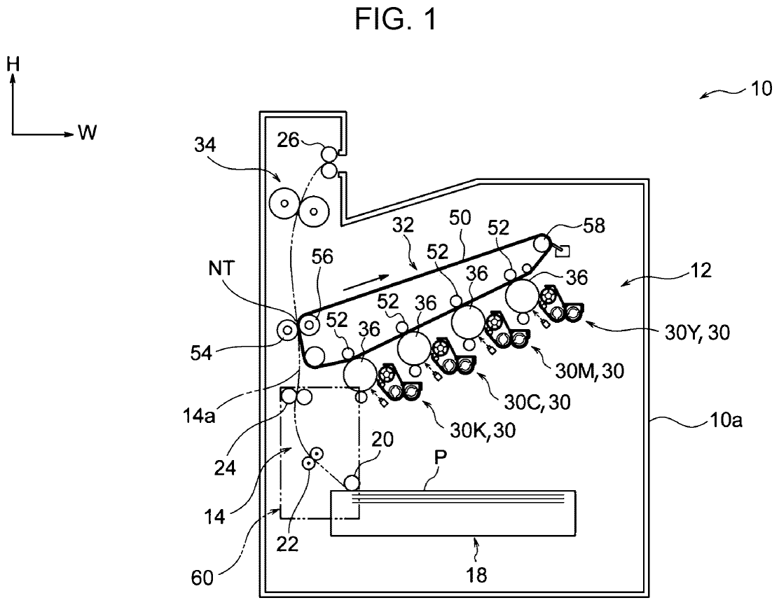

An example of an image forming system according to an exemplary embodiment of the present disclosure will be described with reference to FIGS. 1 to 8. Arrow H in the drawings indicates the vertical direction, which is the up-down direction of the system. Arrow W is perpendicular to arrow H and is a horizontal direction, which is the width direction of the system. Arrow D is perpendicular to arrows H and W and is a horizontal direction, which is the depth direction of the system. First, the image forming apparatus employing the member attachment structure according to the exemplary embodiment will be described.

### Overall Configuration of Image Forming Apparatus 10

As illustrated in FIG. 1, an image forming apparatus 10 includes an image forming section 12 that forms a toner image, and a transport section 14 that transports a sheet member P along a transport path 14a. The image forming apparatus 10 also includes a storage member 18 that stores sheet members P, and a board box 60 that accommodates a control board for controlling the respective components.

In this configuration, in the image forming apparatus 10, the transport section 14 transports a sheet member P accommodated in the storage member 18 along the transport path 14a. Furthermore, the image forming section 12 forms a toner image based on image data supplied from the outside. The toner image is formed on the sheet member P that is being transported, and the sheet member P on which the toner image is formed is discharged to the outside of an apparatus body 10a.

### Image Forming Section 12

As illustrated in FIG. 1, the image forming section 12 includes multiple toner image forming units 30 that form toner images of the respective colors, and a transfer unit 32 that transfers the toner images formed by the toner image forming units 30 to the sheet member P. The image forming section 12 further includes a fixing device 34 that fixes the toner image transferred to the sheet member P by the transfer unit 32 to the sheet member P.

### Toner Image Forming Unit 30

There are multiple toner image forming units 30 that form toner images of the corresponding colors. In this exemplary embodiment, toner image forming units 30Y, 30M, 30C, and 30K corresponding four colors, i.e., yellow (Y), magenta (M), cyan (C) and black (K), are provided. In the following description, when yellow (Y), magenta (M), cyan (C), and black (K) are not distinguished, Y, M, C, and K affixed to the reference signs are omitted.

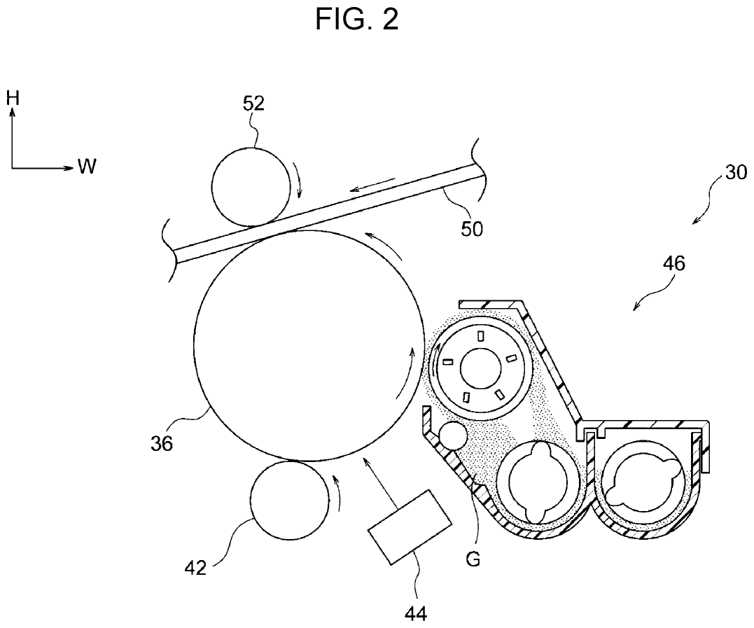

The toner image forming units 30 corresponding to the respective colors basically have the same configuration except for the toner used and, as illustrated in FIG. 2, each include a rotary cylindrical image carrier 36 and a charger 42 for charging the image carrier 36. Each toner image forming unit 30 also includes an exposure device 44 that irradiates the charged image carrier 36 with exposure light to form an electrostatic latent image, and a developing device 46 that develops the electrostatic latent image into a toner image with a developer G containing toner. With this configuration, the toner image forming units 30 corresponding to the respective colors form images of the respective colors using the toner corresponding to the respective colors.

As illustrated in FIG. 1, the image carriers 36 corresponding to the respective colors are in contact with a transfer belt 50 (described in detail below) that travels in a continuous loop. The toner image forming units 30 of yellow (Y), magenta (M), cyan (C), and black (K) are arranged in this order from the upstream side in the traveling direction (indicated by the arrow in FIG. 1) of the transfer belt 50.

### Transfer Unit 32

As illustrated in FIG. 1, the transfer unit 32 includes the transfer belt 50, and first transfer rollers 52 disposed on the opposite side of the transfer belt 50 from the image carriers 36 corresponding to the respective colors. The first transfer rollers 52 transfer the toner images formed on the image carriers 36 corresponding to the respective colors to the transfer belt 50.

The transfer unit 32 also includes a winding roller 56 around which the transfer belt 50 is wound, and a driving roller 58 around which the transfer belt 50 is wound and which transmits a rotational force to the transfer belt 50. Thus, the transfer belt 50 travels in the direction of the arrow in FIG. 1.

The transfer unit 32 also includes a second transfer roller 54 disposed on the opposite side of the transfer belt 50 from the winding roller 56. The second transfer roller 54 transfers the toner image transferred to the transfer belt 50 to a sheet member P. A transfer nip NT, at which the toner image is transferred to the sheet member P, is formed between the second transfer roller 54 and the transfer belt 50.

In this configuration, the toner images are first-transferred to the transfer belt 50 by the first transfer rollers 52 in the order of yellow (Y), magenta (M), cyan (C), and black (K). The toner image is then transferred, by the second transfer roller 54, from the transfer belt 50 to the sheet member P that is transported while being nipped between the transfer belt 50 and the second transfer roller 54. The sheet member P to which the toner image has been transferred is transported toward the fixing device 34.

### Fixing Device 34

As illustrated in FIG. 1, the fixing device 34 is disposed downstream of the transfer nip NT in the transport direction of the sheet member P. The fixing device 34 fixes the toner image, which has been transferred to the sheet member P, to the sheet member P by heating and pressing the toner image.

### Transport Section 14

As illustrated in FIG. 1, the transport section 14 includes a feed roller 20 that feeds a sheet member P accommodated in the storage member 18 to the transport path 14a, and a prevention roller 22 that prevents the sheet member P fed out by the feed roller 20 from being fed in an overlapping manner. The transport section 14 further includes an adjustment roller 24 that adjusts the timing of feeding the sheet member P to the transfer nip NT. The transport section 14 also includes a discharge roller 26 that discharges the sheet member P, to which the toner image has been fixed by the fixing device 34, to the outside of the apparatus body 10a.

### Board Box 60

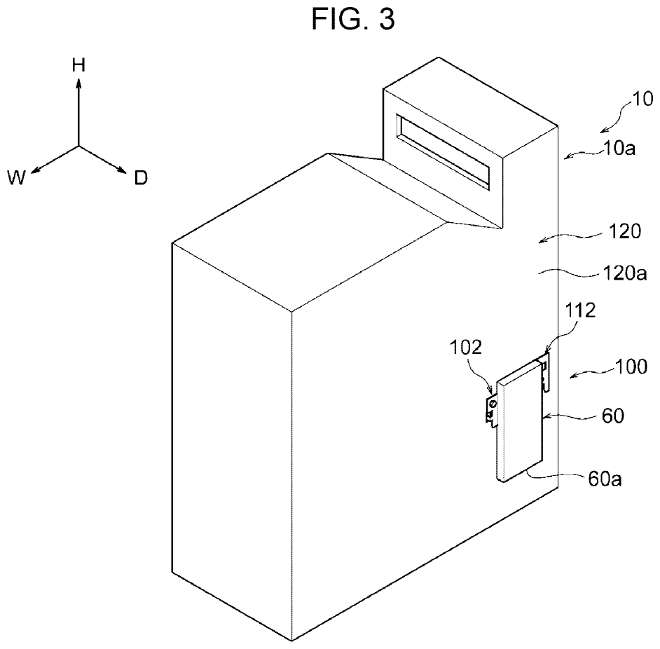

As illustrated in FIG. 3, the board box 60 is attached to an attachment surface 120a of a back plate 120, which constitutes the back surface of the apparatus body 10a, via a member attachment structure 100. The member attachment structure 100 will be described in detail below.

### Configuration of Relevant Part

Next, the member attachment structure 100 (hereinbelow simply referred to as “attachment structure 100”) will be described.

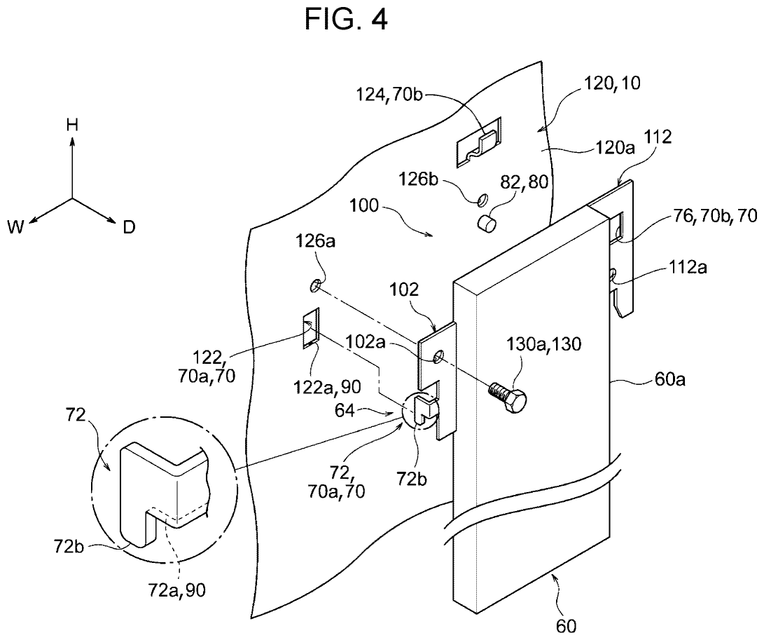

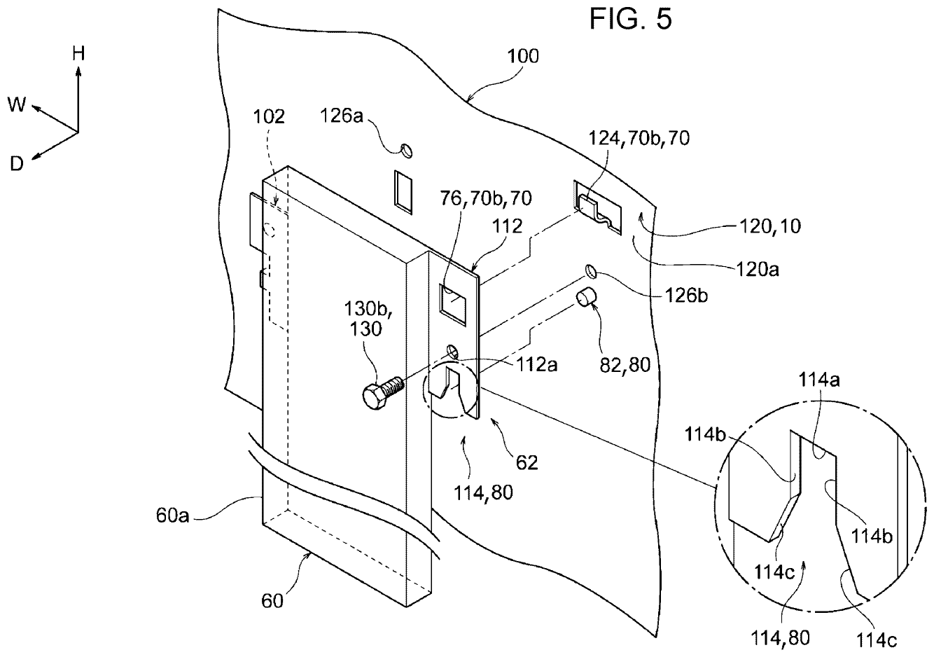

As described above, the attachment structure 100 is a structure for attaching the board box 60 to the attachment surface 120a of the back plate 120 of the image forming apparatus 10. As illustrated in FIGS. 4 and 5, the attachment structure 100 includes the image forming apparatus 10 having the back plate 120, the board box 60, temporary holding parts 70, positioning parts 80 and 90, and fasteners 130. The board box 60 is an example of an attachment member. The image forming apparatus 10 is an example of a main body. The back plate 120 is an example of an attachment plate.

The attachment surface 120a is formed in the back plate 120 of the image forming apparatus 10 and faces the far side in the depth direction. In other words, the attachment surface 120 a is inclined at 90° with respect to the horizontal plane.

The positioning part 80 is provided on the back plate 120 and the board box 60. The positioning part 80 positions a part 62 (see FIG. 5) of the board box 60 with respect to the image forming apparatus 10 in the horizontal direction along the attachment surface 120a and the inclination direction along the attachment surface 120a in a state in which the board box 60 is temporarily held on the image forming apparatus 10 via the temporary holding parts 70. In other words, the positioning part 80 is a partial positioning part that positions the part 62 of the board box 60. The part 62 will be described below.

Here, the “inclination direction along the attachment surface 120a” is a direction in which a force that moves the member placed on the attachment surface 120a downward along the attachment surface 120a acts. In this exemplary embodiment, this direction is the up-down direction.

The “horizontal direction along the attachment surface 120a” is a direction perpendicular to the above-described inclination direction and parallel to the attachment surface 120a. In this exemplary embodiment, this direction is the width direction.

The positioning part 90 is provided on the back plate 120 and the board box 60. The positioning part 90 positions another part 64 (see FIG. 4) of the board box 60 with respect to the image forming apparatus 10 in the inclination direction along the attachment surface 120a in a state in which the board box 60 is temporarily held on the image forming apparatus 10 via the temporary holding parts 70. In other words, the positioning part 90 is a partial positioning part that positions the other part 64 of the board box 60. The other part 64 will be described below. The positioning part 90 is an example of another positioning part.

### Temporary Holding Parts 70

The temporary holding parts 70 are provided on the back plate 120 of the image forming apparatus 10 and the board box 60, and are used when the board box 60 is temporarily held on the back plate 120 of the image forming apparatus 10.

As illustrated in FIGS. 4 and 5, the temporary holding parts 70 are provided on one side (left side in the drawings) in the width direction and the other side (right side in the drawings) in the width direction with respect to the board box 60. In the description below, the temporary holding part 70 provided on one side in the width direction is referred to as a temporary holding part 70a, and the temporary holding part 70 provided on the other side in the width direction is referred to as a temporary holding part 70b.

### Temporary Holding Part 70a

As illustrated in FIG. 4, the temporary holding part 70a includes a rectangular through hole 122 provided in the back plate 120 and extending in the up-down direction, and a hook 72 provided on the board box 60.

The hook 72 is formed on a fixing plate 102 that protrudes from the upper part of a main body 60a of the board box 60 toward one side in the width direction. The thickness direction of the fixing plate 102 corresponds to the depth direction. The hook 72 is formed by cutting and raising (bending) the lower part of the fixing plate 102 toward the near side in the depth direction (toward the through hole 122). The fixing plate 102 is an example of a plate member.

Specifically, the thickness direction of the hook 72 corresponds to the width direction, and the length of the hook 72 in the up-down direction is shorter than the length of the through hole 122 in the up-down direction. The hook 72 has a lower surface 72a extending in the depth direction and facing downward. Furthermore, a catching portion 72b protruding downward from the lower surface 72a is formed at the near end portion, in the depth direction, of the hook 72. As described, the lower surface 72a and the catching portion 72b are formed as an integral part. The hook 72 is supported at one end thereof and has a hook shape with the lower side open.

### Temporary Holding Part 70b

As illustrated in FIG. 5, the temporary holding part 70b includes a hook 124 formed on the back plate 120, and a through hole 76 provided in the board box 60.

The through hole 76 is formed in a fixing plate 112 that protrudes from the upper part of the main body 60a of the board box 60 toward the other side in the width direction. The thickness direction of the fixing plate 112 corresponds to the depth direction. The through hole 76 is provided in the upper part of the fixing plate 112, and has a rectangular shape extending in the width direction.

The hook 124 is formed by cutting and raising a part of the back plate 120. Specifically, the outline of the hook 124 is trimmed, and the trimmed part is bent toward the far side in the depth direction to form the hook 124. The length of the hook 124 in the up-down direction is shorter than the length of the through hole 76 in the up-down direction. In this way, the hook 124 is supported at one end thereof and has a hook shape with the upper side open.

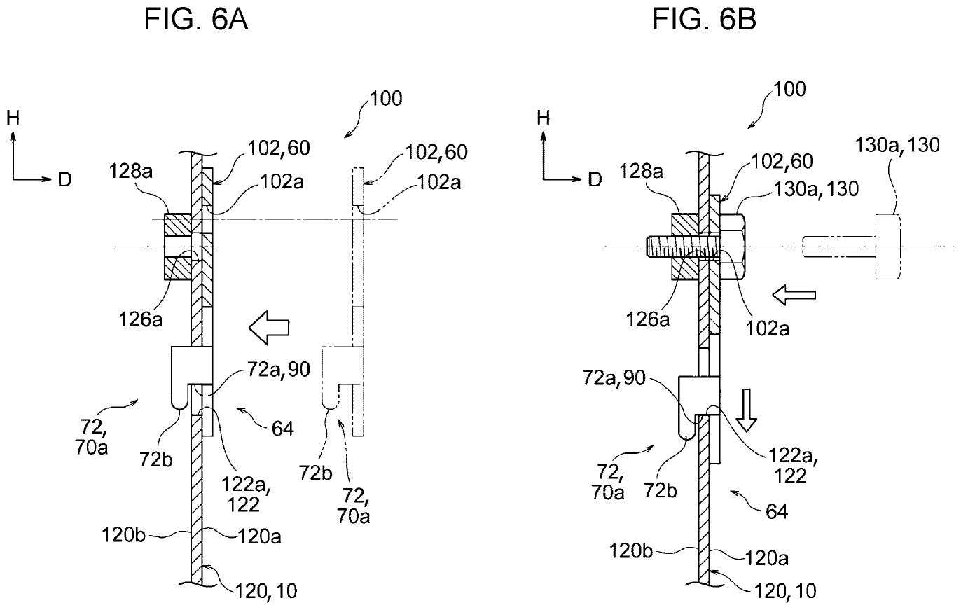

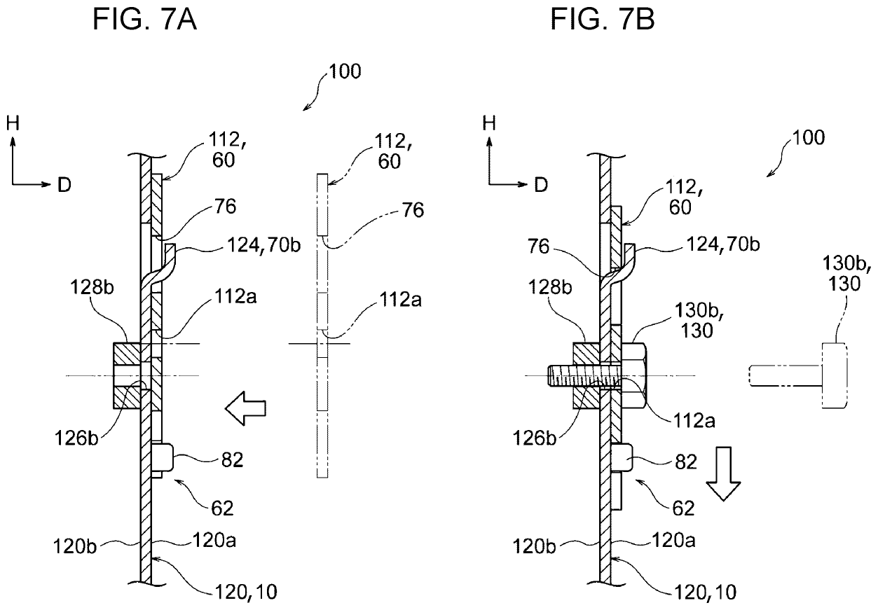

In this configuration, as illustrated in FIGS. 6A and 7A, the board box 60 is moved from the far side to the near side in the depth direction so as to bring the plate surfaces of the fixing plates 102 and 112 into contact with the attachment surface 120a. Specifically, the plate surfaces of the fixing plates 102 and 112 of the board box 60 are brought into contact with the attachment surface 120a such that the hook 72 is inserted through the through hole 122, as illustrated in FIG. 6A, and such that the hook 124 is inserted through the through hole 76, as illustrated in FIG. 7A. In this way, the board box 60 is disposed at a first position where the board box 60 is in contact with the attachment surface 120a.

Then, as illustrated in FIGS. 6A, 6B, 7A, and 7B, the board box 60 disposed at the first position is moved to a second position, which is on the lower side with respect to the first position, along the attachment surface 120a.

As a result, as illustrated in FIGS. 6A and 6B, the lower surface 72a of the hook 72 comes into contact with a lower edge 122a of the through hole 122. Furthermore, the catching portion 72b of the hook 72 is caught by the back surface 120b of the back plate 120. Furthermore, as illustrated in FIGS. 7A and 7B, the hook 124 is caught by the through hole 76. The lower surface 72a is an example of a contact portion. The lower edge 122a is an example of an edge.

In this way, the temporary holding parts 70 cause the board box 60 to be temporarily held on the image forming apparatus 10. In other words, the temporary holding parts 70 realize a state in which the board box 60 is temporarily held on the image forming apparatus 10.

The “state in which the board box 60 is temporarily held on the image forming apparatus 10” is a state in which the board box 60 is hung on the image forming apparatus 10 via the temporary holding parts 70. In this state, even when the board box 60 is moved in the direction normal to the attachment surface 120a with respect to the attachment surface 120a, the board box 60 is not detached from the image forming apparatus 10.

### Positioning Part 80

As described above, the positioning part 80 positions the part 62 of the board box 60 with respect to the image forming apparatus 10. The part 62 of the board box 60 is a lower part of the fixing plate 112, as illustrated in FIG. 5.

The positioning part 80 includes a cylindrical projection 82 provided on the back plate 120, and a U-shaped notch 114 formed in the lower part of the fixing plate 112 of the board box 60.

The notch 114 has a U-shape with the lower side open and includes a contact portion 114a, which comes into contact with the projection 82 in a state in which the board box 60 is moved to the second position, and a pair of sandwiching portions 114b. The contact portion 114a extends in the width direction so as to come into contact with the projection 82 from above. The pair of sandwiching portions 114b extend in the up-down direction so as to sandwich the projection 82 from both sides in the width direction.

The notch 114 further has guide portions 114c. The guide portions 114c are provided in a pair, and guide the projection 82 so that the projection 82 is sandwiched between the pair of sandwiching portions 114b when the board box 60 at the first position is moved to the second position. Specifically, the pair of guide portions 114c are continuous with the lower ends of the pair of sandwiching portions 114b and extend such that the distance therebetween in the width direction increases downward.

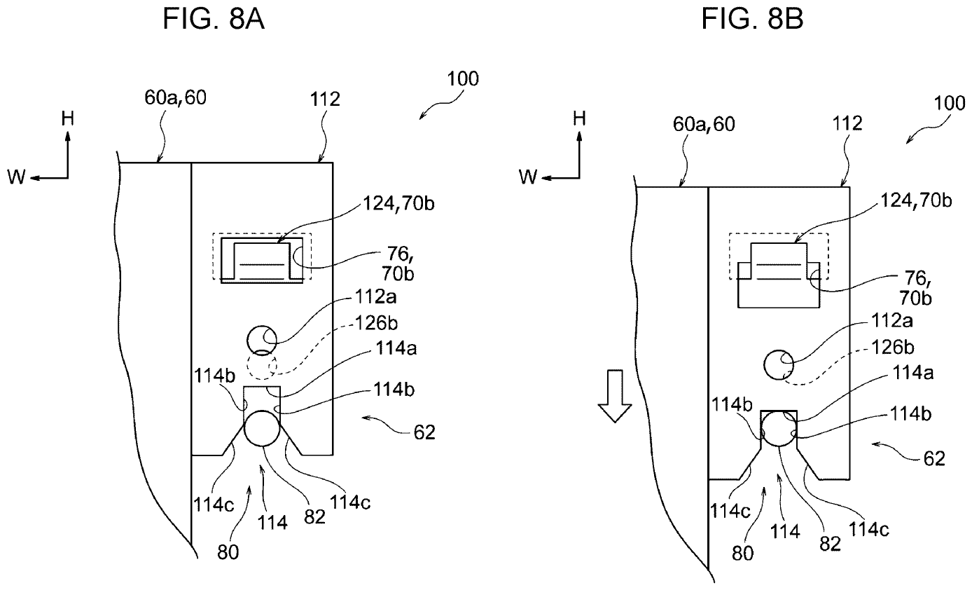

In this configuration, when the board box 60 at the first position is moved to the second position, as illustrated in FIGS. 8A and 8B, the projection 82 is guided by the guide portions 114c and is sandwiched between the pair of sandwiching portions 114b, and the projection 82 comes into contact with the contact portion 114a. As a result, the part 62 of the board box 60 is positioned with respect to the image forming apparatus 10 in the up-down direction and the width direction.

### Positioning Part 90

As described above, the positioning part 90 positions the other part 64 of the board box 60 with respect to the image forming apparatus 10. The other part 64 of the board box 60 is away from the one part 62 (see FIG. 5) in the width direction, and is the lower part of the fixing plate 102 as illustrated in FIG. 4.

The positioning part 90 includes a lower surface 72a of the hook 72 and a lower edge 122a of the through hole 122.

In this configuration, when the board box 60 at the first position is moved to the second position, as illustrated in FIGS. 6A and 6B, the lower surface 72a of the hook 72 comes into contact with the lower edge 122a of the through hole 122 in the up-down direction. As a result, the other part 64 of the board box 60 is positioned with respect to the image forming apparatus 10 in the up-down direction.

### Fastener 130

There are multiple fasteners 130 with which the board box 60 is attached to the image forming apparatus 10. Specifically, there is a fastener 130 (see FIG. 4) with which the fixing plate 102 is attached to the back plate 120, and a fastener 130 (see FIG. 5) with which the fixing plate 112 is attached to the back plate 120. The fastener with which the fixing plate 102 is attached to the back plate 120 is a fastener 130a. The fastener with which the fixing plate 112 is attached to the back plate 120 is a fastener 130b.

As illustrated in FIGS. 4 and 6B, the fastener 130a is a bolt and is inserted through the through hole 102a provided in the fixing plate 102 and the through hole 126a provided in the back plate 120. The fastener 130a is fastened to a nut 128a attached to the back surface 120b of the back plate 120.

As illustrated in FIGS. 6A and 6B, when the board box 60 at the first position is moved to the second position, the through hole 102a and the through hole 126a form a continuous hole.

As illustrated in FIGS. 5 and 7B, the fastener 130b is a bolt and is inserted through the through hole 112a provided in the fixing plate 112 and the through hole 126b provided in the back plate 120. The fastener 130b is fastened to a nut 128b attached to the back surface 120b of the back plate 120.

As illustrated in FIGS. 7A and 7B, when the board box 60 at the first position is moved to the second position, the through hole 112a and the through hole 126b form a continuous hole.

### Operation

Next, a task of attaching the board box 60 to the back plate 120 of the image forming apparatus 10 will be described.

First, as illustrated in FIGS. 4 and 5, an operator disposes the board box 60 on the far side in the depth direction with respect to the back plate 120 of the image forming apparatus 10 so that the board box 60 faces the attachment surface 120a. In this state, the through hole 122 in the back plate 120 and the hook 72 on the fixing plate 102 face each other (see FIG. 4), and the hook 124 on the back plate 120 and the through hole 76 in the fixing plate 112 face each other (see FIG. 5).

In this state, the operator moves the board box 60 to the near side in the depth direction. Then, the operator brings the plate surfaces of the fixing plate 102 and the fixing plate 112 of the board box 60 into contact with the attachment surface 120a to dispose the board box 60 at the first position. Specifically, as illustrated in FIG. 6A, in a state in which the board box 60 is disposed at the first position, the hook 72 is inserted through the through hole 122. Furthermore, as illustrated in FIG. 7A, the hook 124 is inserted through the through hole 76.

In a state in which the board box 60 is disposed at the first position, the operator reduces a supporting force for supporting the board box 60, allowing the board box 60 to move in the direction of gravity along the attachment surface 120a so that the board box 60 is disposed at the second position, as illustrated in FIGS. 6B and 7B.

Specifically, as illustrated in FIG. 6B, the lower surface 72a of the hook 72 comes into contact with the lower edge 122a of the through hole 122. Furthermore, the catching portion 72b of the hook 72 is caught by the back surface 120b of the back plate 120. Furthermore, as illustrated in FIG. 7B, the hook 124 is caught by the through hole 76.

In this way, the temporary holding parts 70 cause the board box 60 to be hooked and temporarily held on the image forming apparatus 10. In other words, the board box 60 is temporarily held on the image forming apparatus 10 via the temporary holding parts 70.

Furthermore, by moving the board box 60 disposed at the first position to the second position, the lower surface 72a of the hook 72 comes into contact with the lower edge 122a of the through hole 122 in the up-down direction, thus positioning the other part 64 with respect to the image forming apparatus 10 in the up-down direction.

Furthermore, the part 62 of the board box 60 is positioned with respect to the image forming apparatus 10 in the up-down direction and the width direction. Specifically, as illustrated in FIGS. 8A and 8B, the projection 82 is guided by the guide portions 114c and sandwiched between the pair of sandwiching portions 114b, and the projection 82 comes into contact with the contact portion 114a. As a result, the part 62 is positioned with respect to the image forming apparatus 10 in the up-down direction and the width direction.

Then, in a state in which the board box 60 is positioned with respect to the image forming apparatus 10, the fastener 130a is inserted through the through hole 102a provided in the fixing plate 102 and the through hole 126a provided in the back plate 120, as illustrated in FIG. 6B. The fastener 130a is then fastened to the nut 128a attached to the back surface 120b of the back plate 120.

Furthermore, as illustrated in FIG. 7B, the fastener 130b is inserted through the through hole 112a provided in the fixing plate 112 and the through hole 126b provided in the back plate 120. The fastener 130b is then fastened to the nut 128b attached to the back surface 120b of the back plate 120.

When the board box 60 is temporarily held on the image forming apparatus 10 in this way, the board box 60 is positioned with respect to the image forming apparatus 10, enabling the board box 60 to be attached to the image forming apparatus 10 with the fasteners 130.

### Conclusion

As described above, in the attachment structure 100, when the board box 60 is temporarily held on the image forming apparatus 10 in this way, the board box 60 is positioned with respect to the image forming apparatus 10, enabling the board box 60 to be attached to the image forming apparatus 10 with the fasteners 130.

In the attachment structure 100, as a result of the board box 60 being moved from the first position to the second position, the board box 60 becomes ready to be attached to the back plate 120 of the image forming apparatus 10 with the fasteners 130.

In the attachment structure 100, the projection 82 to be in contact with the contact portion 114a and the pair of sandwiching portions 114b protrudes from the attachment surface 120a toward the far side in the depth direction and has a circular cross-section. Hence, even when the projection 82 rotates in the circumferential direction of the projection 82, the part 62 is positioned by the positioning part 80.

In addition, in the attachment structure 100, the pair of guide portions 114c are provided, which guide the projection 82 such that the projection 82 is sandwiched between the pair of sandwiching portions 114b when the board box 60 at the first position is moved to the second position.

In the attachment structure 100, the hook 72 has the lower surface 72a and the catching portion 72b.

In the attachment structure 100, the hook 72 having the lower surface 72a and the catching portion 72b is formed by bending a part of the fixing plate 102.

Although a specific exemplary embodiment of the present disclosure has been described in detail above, the present disclosure is not limited thereto, and it is apparent to those skilled in the art that various other exemplary embodiments are possible within the scope of the present disclosure. For example, in the above-described exemplary embodiment, the attachment surface 120 a is inclined at 90°with respect to the horizontal plane, but it is only necessary that the attachment surface is inclined with respect to the horizontal plane. The inclination angle with respect to the horizontal plane is not limited to 90° as long as it is larger than 0°, so that the board box 60 comes into contact with the image forming apparatus 10.

In the exemplary embodiment, the projection 82 protrudes from the attachment surface 120a, and the U-shaped notch 114 is provided in the fixing plate 112, but the projection may protrude from the fixing plate and the U-shaped notch may be formed on the attachment surface.

In the exemplary embodiment, one hook 72 is provided on the board box 60 and the other hook 124 is provided on the back plate 120, but both hooks may be provided on the board box or both hooks may be provided on the back plate. The number of hooks may be one. It is only necessary that the board box 60 is hung on the back plate 120 and is temporarily held.

In the exemplary embodiment, the fasteners 130 are bolts, but may be other fasteners, such as screws.

In the exemplary embodiment, the attachment structure 100 is used in the image forming apparatus 10, but the attachment structure 100 may be used in other apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A member attachment structure comprising:
a main body;
an attachment member to be attached to an attachment surface formed in the main body and inclined with respect to a horizontal plane;
a temporary holding part that is provided on the main body and the attachment member and via which the attachment member is temporarily held on the main body;
a positioning part that is provided on the main body and the attachment member and that positions a part of the attachment member with respect to the main body in a horizontal direction along the attachment surface and in an inclined direction along the attachment surface in a state in which the attachment member is temporarily held on the main body via the temporary holding part;
another positioning part that is provided on the main body and the attachment member and that positions another part of the attachment member, away from the part in the horizontal direction, with respect to the main body in the inclination direction in a state in which the attachment member is temporarily held on the main body via the temporary holding part; and
a fastener with which the attachment member positioned by the positioning part and the other positioning part is attached to the main body.
   (((2)))

The member attachment structure according to (((1))), wherein:
when the attachment member disposed at a first position, where the attachment member is in contact with the attachment surface, is moved to a second position located below the first position in the inclination direction along the attachment surface, the attachment member is hung on the main body via the temporary holding part, and the temporary holding part causes the attachment member to be temporarily held on the main body,
the positioning part positions the part with respect to the main body when the attachment member is moved from the first position to the second position, and
the other positioning part positions the other part with respect to the main body when the attachment member is moved from the first position to the second position.
   (((3)))

The member attachment structure according to (((2))),
wherein the positioning part includes: a projection having a circular cross-section and protruding from the attachment surface of the main body; and a contact portion and a pair of sandwiching portions provided on the attachment member, the contact portion being configured to come into contact with the projection from above in the inclination direction and the pair of sandwiching portions sandwiching the projection from both sides in the horizontal direction when the attachment member at the first position is moved to the second position.
   (((4)))

The member attachment structure according to (((3))),
wherein the positioning part includes a guide portion that is provided on the attachment member and that guides the projection such that the projection is sandwiched between the pair of sandwiching portions when the attachment member at the first position is moved to the second position.
   (((5)))

The member attachment structure according to any one of (((1))) to (((4))), wherein:
when the attachment member disposed at the first position, where the attachment member is in contact with the attachment surface, is moved to the second position located below the first position in the inclination direction along the attachment surface, the attachment member is hung on the main body via the temporary holding part, and the temporary holding part causes the attachment member to be temporarily held on the main body,
the attachment surface of the main body is formed on an attachment plate provided on the main body,
the other positioning part includes a through hole provided in the attachment plate, and a contact portion that is provided on the attachment member, is inserted through the through hole in a state in which the attachment member is disposed at the first position, and comes into contact with an edge of the through hole in the inclination direction when the attachment member at the first position is moved to the second position, and
the temporary holding part includes a catching portion that is formed integrally with the contact portion at a distal end of the contact portion and that is caught by a back surface of the attachment plate on a side opposite to the attachment surface when the attachment member is moved to the second position.
   (((6)))

The member attachment structure according to (((5))),
wherein the attachment member is provided with a plate member that comes into contact with the attachment surface at a plate surface thereof, and the contact portion and the catching portion are formed by bending a portion of the plate member.

What is claimed is:

1. A member attachment structure comprising:
a main body;
an attachment member to be attached to an attachment surface formed in the main body and inclined with respect to a horizontal plane;
a temporary holding part that is provided on the main body and the attachment member and via which the attachment member is temporarily held on the main body;
a positioning part that is provided on the main body and the attachment member and that positions a part of the attachment member with respect to the main body in a horizontal direction along the attachment surface and in an inclined direction along the attachment surface in a state in which the attachment member is temporarily held on the main body via the temporary holding part;
another positioning part that is provided on the main body and the attachment member and that positions another part of the attachment member, away from the part in the horizontal direction, with respect to the main body in the inclination direction in a state in which the attachment member is temporarily held on the main body via the temporary holding part; and
a fastener with which the attachment member positioned by the positioning part and the other positioning part is attached to the main body.

2. The member attachment structure according to claim 1, wherein:
when the attachment member disposed at a first position, where the attachment member is in contact with the attachment surface, is moved to a second position located below the first position in the inclination direction along the attachment surface, the attachment member is hung on the main body via the temporary holding part, and the temporary holding part causes the attachment member to be temporarily held on the main body,
the positioning part positions the part with respect to the main body when the attachment member is moved from the first position to the second position, and
the other positioning part positions the other part with respect to the main body when the attachment member is moved from the first position to the second position.

3. The member attachment structure according to claim 2,
wherein the positioning part includes: a projection having a circular cross-section and protruding from the attachment surface of the main body; and a contact portion and a pair of sandwiching portions provided on the attachment member, the contact portion being configured to come into contact with the projection from above in the inclination direction and the pair of sandwiching portions sandwiching the projection from both sides in the horizontal direction when the attachment member at the first position is moved to the second position.

4. The member attachment structure according to claim 3,
wherein the positioning part includes a guide portion that is provided on the attachment member and that guides the projection such that the projection is sandwiched between the pair of sandwiching portions when the attachment member at the first position is moved to the second position.

5. The member attachment structure according to claim 1, wherein:
when the attachment member disposed at the first position, where the attachment member is in contact with the attachment surface, is moved to the second position located below the first position in the inclination direction along the attachment surface, the attachment member is hung on the main body via the temporary holding part, and the temporary holding part causes the attachment member to be temporarily held on the main body,
the attachment surface of the main body is formed on an attachment plate provided on the main body,
the other positioning part includes a through hole provided in the attachment plate, and a contact portion that is provided on the attachment member, is inserted through the through hole in a state in which the attachment member is disposed at the first position, and comes into contact with an edge of the through hole in the inclination direction when the attachment member at the first position is moved to the second position, and
the temporary holding part includes a catching portion that is formed integrally with the contact portion at a distal end of the contact portion and that is caught by a back surface of the attachment plate on a side opposite to the attachment surface when the attachment member is moved to the second position.

6. The member attachment structure according to claim 5,
wherein the attachment member is provided with a plate member that comes into contact with the attachment surface at a plate surface thereof, and the contact portion and the catching portion are formed by bending a portion of the plate member.
